(19) United States
(12) Patent Application Publication
(10) Pub. No.: US 2004/0184767 A1
(43) Pub. Date: Sep. 23, 2004

(54) Video data recording apparatus and video data recording method

(75) Inventors: Koji Maruyama, Akishima-shi (JP); Tsutomu Mizusawa, Fukaya-shi (JP)

Correspondence Address: Finnegan, Henderson, Farabow,, Garrette & Dunner, L.L.P., 1300 I Street, N.W., Washington, DC, 20005-3315, US

(73) Assignee: KABUSHIKI KAISHA TOSHIBA

(21) Appl. No.: 10/765,144

(22) Filed: Jan. 28, 2004

(30) Foreign Application Priority Data
Jan. 31, 2003 (JP) 2003-024856

(51) Int. Cl. H04N 5/91

(52) U.S. Cl. 386/46

(57) ABSTRACT

There is disclosed a video data recording apparatus in which video data recorded in an HDD is decoded, and converted to that of a broadcasting system other than that of the video data by a broadcasting system conversion section. The converted video data is supplemented by a frame synchronizer, compressed, and thereafter recorded in a DVD.

### CROSS-REFERENCE TO RELATED APPLICATIONS

This application is based upon and claims the benefit of priority from the prior Japanese Patent Application No. 2003-024856, filed Jan. 31, 2003, the entire contents of which are incorporated herein by reference.

### BACKGROUND OF THE INVENTION

1. Field of the Invention

The present invention relates to a recording/reproducing system of digital video data, especially to a technique of converting a broadcasting system and recording the data.

2. Description of the Related Art

For a TV broadcasting system, in various countries such as Japan and U.S.A., the NTSC system is employed, and this system represents general standards of video signals in the countries. In Western countries, the PAL system is employed. In ex-Communist countries centering on the former Soviet Union, the standard called SECAM is employed.

For example, the NTSC system has the number of scanning lines: 525/F., field frequency: 60/S, the PAL system has the number of scanning lines: 625/F., field frequency: 50/S, and these systems do not have mutual interchangeablility. Therefore, video recorded, for example, in DVD in the PAL system cannot be reproduced with a DVD player to which the NTSC system is applied and, needless to say, vice versa.

In Jpn. Pat. Appln. KOKAI Publication No. 2002-125193, a technique of converting an HD video signal to an SD (NTSC) video signal is disclosed.

In the conventional apparatus, the video signal cannot be converted to that of the different broadcasting system employed overseas. Also, the conventional apparatus does not have a function of inputting and recording the signals of the broadcasting systems which are different from each other.

### BRIEF SUMMARY OF THE INVENTION

According to one aspect of the present invention, there is provided a video data recording apparatus comprising: a first encode control section which uses an encoder to encode broadcast video data; a first recording section which records the encoded video data; a decoder which decodes the video data recorded in the first recording section; a broadcasting system conversion section which converts the decoded video data to video data of a broadcasting system other than that of the video data; a second encode control section which uses the encoder to encode the video data of the other broadcasting system converted by the broadcasting system conversion section; and a second recording section which records the encoded video data of the other broadcasting system.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a recording/reproducing apparatus according to one embodiment of the present invention;

FIG. 2 shows one example of the broadcasting system conversion section 9;

FIG. 3 shows a relation of fields in input/output of the field memory 22;

FIGS. 4A and 4B show a scanning line interpolation process performed in accordance with the conversion of the field attributes of ODD and EVEN;

FIG. 5 shows that the number of scanning lines in PAL signal is reduced and converted to 525 lines in NTSC signal;

FIG. 6 is a flowchart showing a control operation of the present recording/reproducing apparatus;

FIG. 7 is a block diagram showing the constitution of the recording/reproducing apparatus according to another embodiment of the present invention;

FIG. 8 is a block diagram showing the constitution of the recording/reproducing apparatus according to the second embodiment;

FIG. 9 is a flowchart showing an operation of the second embodiment;

FIG. 10 is a block diagram showing the constitution of the recording/reproducing apparatus according to the third embodiment; and

FIG. 11 is a flowchart showing the operation of the third embodiment.

### DETAILED DESCRIPTION OF THE INVENTION

Embodiments of the present invention will be described in detail with reference to the drawing.

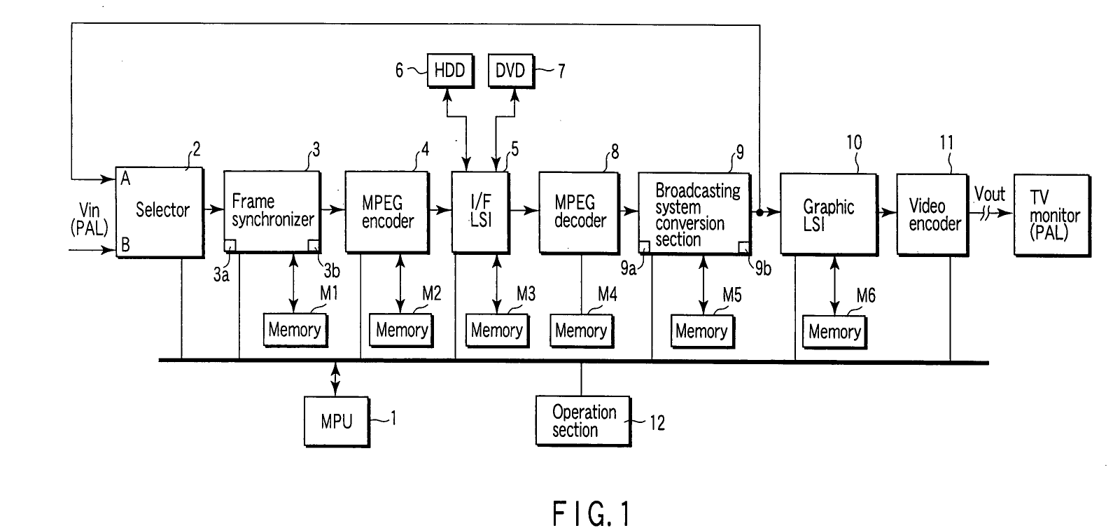

FIG. 1 is a block diagram showing a constitution of a digital video signal recording/reproducing apparatus according to one embodiment of the present invention. In the present embodiment, an example will be described in which systems of input video data Vin and a TV monitor connected to the present apparatus are PAL systems. However, the present invention is not limited to this, and can be applied even to a case where the systems of the input video data Vin and the TV monitor connected to the apparatus are NTSC systems.

An MPU 1 controls each block based on an instruction input from a user via an operation section 12. Here, the operation section 12 may also be a remote controller. A selector 2 selects and outputs one of video data supplied to input ends A and B in response to a control signal from the MPU 1.

A frame synchronizer 3 uses a memory M1 to supplement non-standard video data, and outputs the supplemented video data. For example, when the number of scanning lines of the inputted video data is smaller than that of the standard video, the frame synchronizer 3 supplements the input video data to obtain the same scanning line number as that of standard video, and outputs the standard video data. The frame synchronizer 3 includes a PAL system data supplement section 3a which supplements PAL system video data, and an NTSC system data supplement section 3b which supplements NTSC system video data. One of PAL system data supplement and NTSC system data supplement is performed based on the instruction of the MPU 1. Alternatively, self-propelled signal processing may also be performed here. That is, the frame synchronizer 3 may also detect the broadcasting system of the input image data to supplement the data in accordance with the detected broadcasting system. In this case, the broadcasting system of the input image data is detected based on a synchronous data interval of the input video data.

An MPEG encoder 4 uses a memory M2 to compress the video data in accordance with an MPEG system. An interface (I/F) LSI 5 sets an input/output path of the video data based on the instruction from the MPU 1. In this case, a memory M3 is used as a data buffer. For example, the I/F LSI 5 sets the input/output path in such a manner that the video data from the MPEG encoder 4 is recorded in one or both of a hard disk drive (HDD) 6 and DVD drive 7.

An MPEG decoder 8 uses a memory M4 to extend the compressed video data based on the MPEG system. Based on the instruction from the MPU 1, a broadcasting system conversion section 9 uses a memory MS to perform a process of converting PAL system video data to NTSC system video data, or a process of converting the NTSC system video data to the PAL system video data.

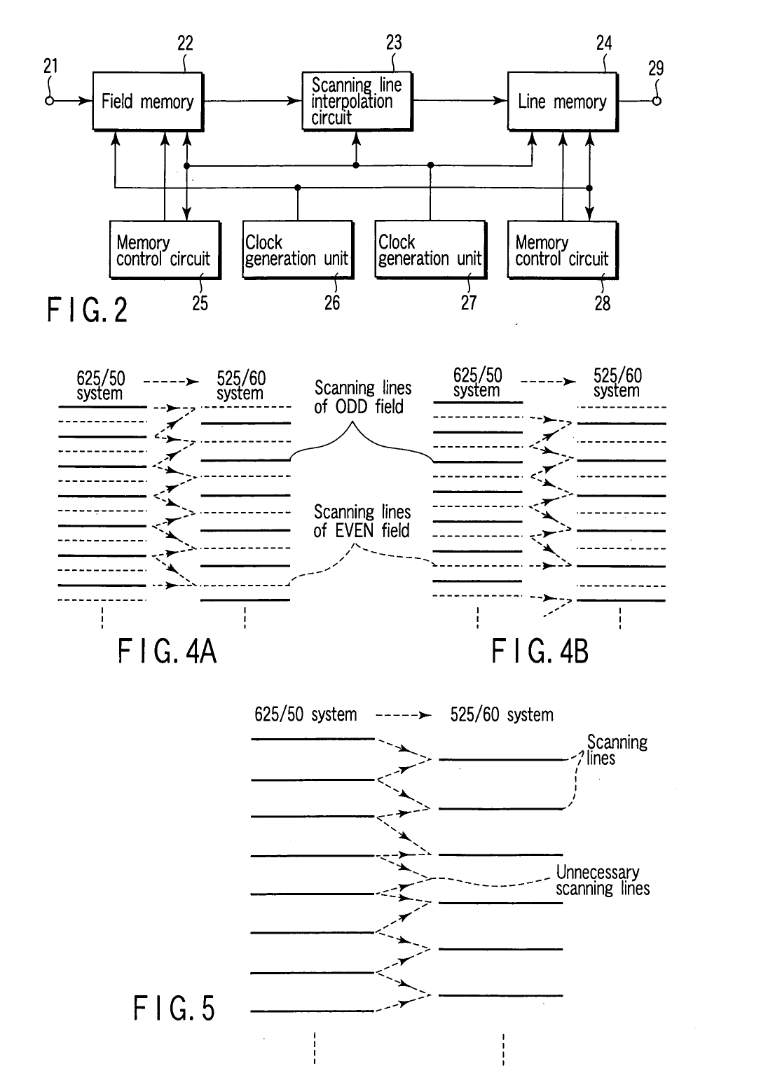

FIG. 2 shows one example of the broadcasting system conversion section 9. The broadcasting system conversion section includes an input terminal 21, field memory 22, scanning line interpolation circuit 23, line memory 24, memory control circuit 25, clock generation unit 26, clock generation unit 27, memory control circuit 28, and output terminal 29. An operation of the broadcasting system conversion section will hereinafter be described. Here, a television signal to be converted, which is inputted into the input terminal 21, is a PAL component multiplexed signal of a 625/50 system, and is converted to an NTSC component multiplexed signal of a 525/60 system and outputted to the output terminal 29.

When the digitized component multiplexed signal of the PAL system is inputted into the input terminal 21, the clock generation unit 26 generates a clock in synchronization with the input PAL signal, and the input PAL signal is written in the field memory 22 by the clock at a field frequency of 50 Hz. The signal is read from the field memory 22 in response to a control signal of the memory control circuit 25 at a field frequency of 60 Hz.

When the signal is read at the same clock as that at a write time and at a clock in synchronization with the input PAL signal, a signal read per frame is limited to 50/60 from a relation in which a field frequency is 60/50 times. That is, only 50/60 of 625 scanning lines of the PAL signal per frame are read. Then, the signal is read from the field memory 22 at the clock by the clock generation unit 27 separate from the clock generation unit 26, the scanning line frequency is converted, and the read of all the 625 scanning lines of the PAL signal per frame is enabled. Assuming that the clock generation unit 27 generates, for example, a clock of 50/60 of the frequency with respect to the frequency of the clock of the clock generation unit 26, the scanning line frequency is 60/50 times, that is, 1.2 times. Even when the field frequency is converted to 60 Hz from 50 Hz, the read of 625 scanning lines per frame is enabled.

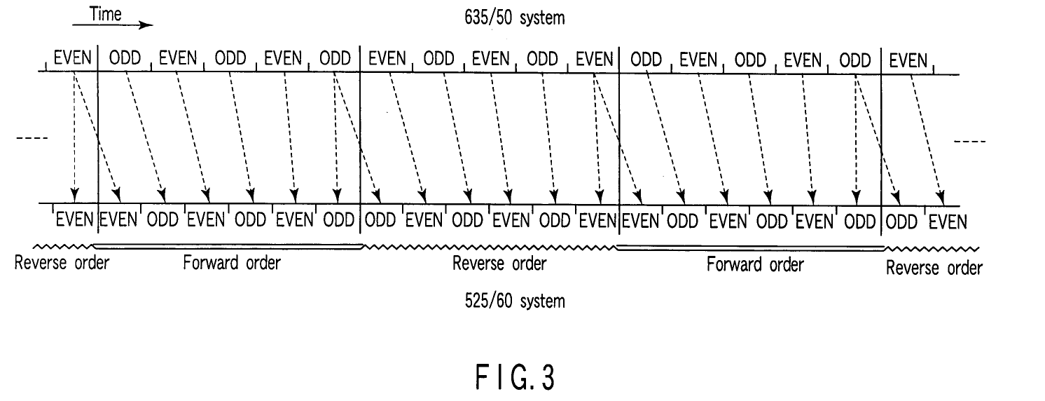

FIG. 3 shows a relation of fields in input/output of the field memory 22. Signals whose scanning line frequency and field frequency are converted as described above are subjected to a repeat process by a field unit for the conversion of the field frequency. Therefore, as shown in FIG. 3, ODD and EVEN fields are not correctly alternatively arranged.

Therefore, a scanning line interpolation process is performed in the scanning line interpolation circuit 23 so as to correctly alternately output the ODD and EVEN fields. In the interpolation process of the scanning lines, a difference of a spatial position between the scanning lines of the PAL and NTSC signals is corrected. In this case, field attributes of ODD and EVEN are also simultaneously converted. That is, when the ODD and EVEN fields are correctly arranged in order, the scanning line interpolation process is performed so as to interpolate the ODD field scanning lines of the 525/60 system from those of the 625/50 system. Alternatively, the EVEN field scanning lines of the 525/60 system are interpolated from the EVEN field scanning lines of the 625/50 system. When the order of the ODD and EVEN fields is changed, as shown in FIG. 4A, the EVEN field scanning lines of the 525/60 system are interpolated from the ODD field scanning lines of the 625/50 system. Alternatively, as shown in FIG. 4B, the ODD field scanning lines of the 525/60 system are interpolated from the EVEN field scanning lines of the 625/50 system. In this manner, the scanning line interpolation process is performed in accordance with the conversion of the field attributes of ODD and EVEN. The ODD and EVEN fields are alternately correctly outputted by the scanning line interpolation process.

Moreover, as shown in FIG. 5, in addition to 525 scanning lines necessary as the NTSC signal, unnecessary signals are also prepared as the NTSC signals at a ratio of one in about six lines from 625 scanning lines per frame to be inputted in the scanning line interpolation circuit 23, and 625 scanning lines in total per frame are outputted to the line memory 24. The line memory 24 writes 625 scanning lines per frame by the clock of the clock generation unit 27. During output, the scanning lines are read by the clock of the clock generation unit 26, and the scanning line frequency is converted to that of the NTSC system. Moreover, the unnecessary signal is controlled not to be read as the NTSC signal in response to the control signal of the memory control circuit 28, and the number of scanning lines is reduced and converted to 525. In this manner, the component multiplexed signal converted in the NTSC system is outputted to the output terminal 29.

The broadcasting system conversion section 9 includes a PAL/NTSC conversion section 9a and an NTSC/PAL conversion section 9b. Since the broadcasting system conversion section 9 converts the system to NTSC from PAL or to PAL from NTSC in this manner, the present recording/reproducing apparatus can be used in both areas of a PAL sphere and NTSC sphere without changing a basic constitution. It is to be noted that various conversion systems such as conversion to SECAM from PAL and to PAL from SECAM can be applied to the broadcasting system conversion section 9. Needless to say, the broadcasting system conversion section 9 may also perform the system conversion to NTSC from PAL or to PAL from NTSC.

A graphic LSI 10 synthesizes and outputs video (main video) output from the MPEG decoder 8 and on-screen display information (OSD) of a system (PAL system herein) specific to the present recorder/player set including a TV monitor in response to the instruction of the MPU 1. A video encoder 11 converts a digital video signal to an analog video signal.

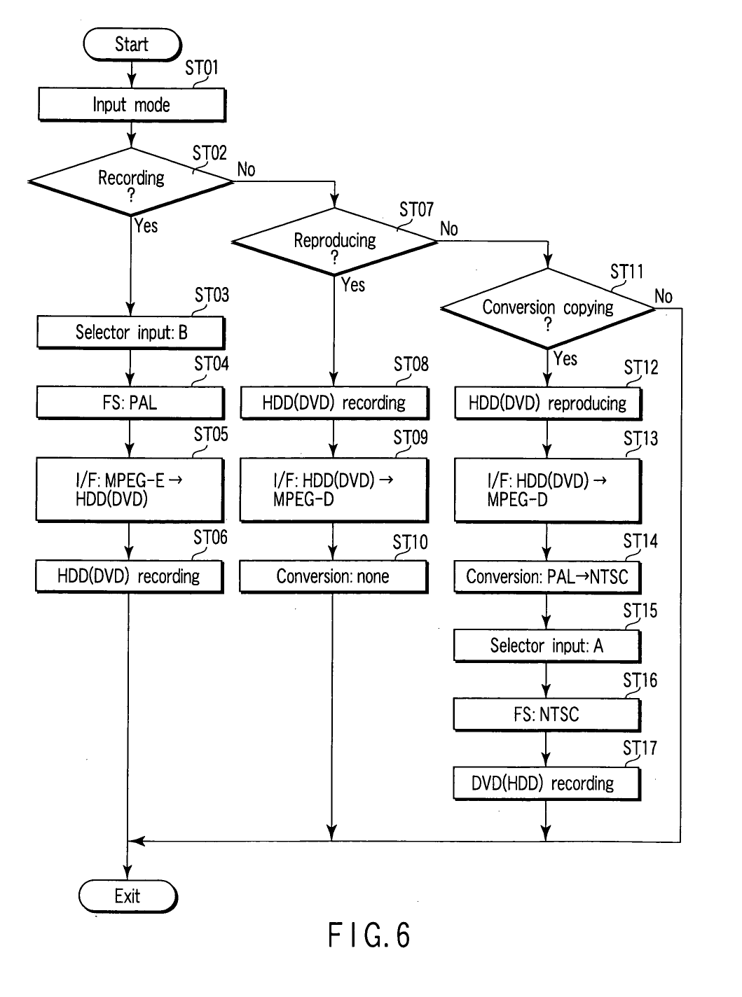

FIG. 6 is a flowchart mainly showing a control operation of the present recording/reproducing apparatus. The operation of the present recording/reproducing apparatus will hereinafter be described with reference to this flowchart.

First, an operation at the time of recording will be described.

When an operation mode is input via the operation section 12 from a user, the MPU 1 judges whether the mode indicates the recording (ST01, ST02). When the operation mode indicates the recording (YES in ST02), the MPU 1 sets the input of the selector 2 to “B”, and sets the frame synchronizer (FS) 3 to “PAL system” (ST03, ST04). The MPU 1 sets a data path of the I/F LSI 5 to record the video data based on the instruction input via the operation section 12 from the user. That is, the MPU 1 sets the data path of the I/F LSI 5 to the HDD 6 or the DVD drive 7 from the MPEG encoder 4. Here, it is assumed that the MPU 1 sets the data path of the I/F LSI 5 to “to the HDD 6 from the MPEG encoder 4”, and sets the HDD 6 into a recording mode (ST05, ST06).

After this setting, the PAL system digital video data from a TV tuner or an external input terminal (not shown) is input into the frame synchronizer 3 via the selector 2. The frame synchronizer 3 supplements the input non-standard video data. For example, when the scanning line number of the input video data Vin is 620/F, the frame synchronizer 3 supplements the scanning lines of the input video data Vin to obtain a scanning line number 625/F of PAL standard video data. The standard video data supplemented by the frame synchronizer 3 is supplied to the MPEG encoder 4. Here, the video data is compressed in the MPEG system, and supplied and recorded in the HDD 6 via the I/F LSI 5.

Next, reproduction of the video data will be described.

When the reproducing of the HDD 6 or the DVD drive 7 is instructed via the operation section 12 from the user (YES in ST07), the MPU 1 sets the HDD 6 or the DVD drive 7 to “reproducing mode” (ST08). It is assumed here that the reproduction of the HDD 6 is instructed. Furthermore, the MPU 1 sets the data path of the I/F LSI 5 to “the MPEG decoder from HDD”, and sets the broadcasting system conversion section 9 to “no conversion” (ST09, ST10).

By this setting, the data recorded in the HDD 6 is supplied to the MPEG decoder 8 via the I/F LSI 5. Usually the MPEG decoder 8 decodes, for example, the input PAL system video data as such. The decoded video data is supplied to the TV monitor via the graphic LSI 10 and video encoder 11 to display the video.

Next, the converting and copying of the broadcasting system of the video data will be described.

For example, when an instruction for converting the broadcasting system of the video data recorded in the HDD 6 and copying the data into the DVD drive 7 is input via the operation section 12 from the user (YES in ST11), the MPU 1 sets the HDD 6 to the “reproducing mode”, sets the data path of the I/F LSI 5 to “the MPEG decoder 8 from HDD 6”, sets the broadcasting system conversion section to “the NTSC from PAL”, sets the input of the selector 2 to “A”, sets the data supplement of the frame synchronizer (FS) to “the NTSC system”, and sets the DVD drive to the “recording mode” (ST12 to ST17).

By this setting, the data recorded in the HDD 6 is output to the MPEG decoder 8 via the I/F LSI 5. Usually the MPEG decoder 8 decodes, for example, the input PAL system broadcasting signal as such, and outputs the signal to the subsequent stage. The decoded video signal is supplied to the broadcasting system conversion section 9. In this example, the video data of the PAL system is converted to that of the NTSC system. The converted video signal is returned to the selector 2.

Here, the selector 2 selects the video signal from the broadcasting system conversion section 9, and sends the signal to the frame synchronizer 3. The frame synchronizer 3 carries out a frame synchronize process of the NTSC broadcasting system with respect to the input video data. The video signal subjected to the frame synchronize process is compressed by the MPEG encoder 4, and recorded by the DVD drive 7 via the I/F LSI 5. At this time, the MPU 1 converts the video data compressed by the MPEG encoder 4 into a DVD-video format, and records the video data in recordable DVD such as DVD-R charged in the DVD drive 7. At this time, the I/F LSI 5 may perform data transfer into the MPEG decoder 8 from the HDD 6 and that into the DVD drive 7 from the MPEG encoder 4 in a time division system, or may use two paths to simultaneously perform the data transfer. It is to be noted that for the copying without performing the broadcasting system conversion, the MPU 1 simply reads the video data recorded into the HDD 6, converts the data into the DVD-video format, and records the data in the DVD.

Next, an operation for displaying the decoded video data is displayed on the TV monitor will be described.

As described above, when the video data recorded without performing any broadcasting system conversion is reproduced, for example, the video data of the PAL system from the MPEG decoder 8 is input to the graphic LSI 10 without converting the system. The graphic LSI 10 synthesizes and outputs the video (main video) output from the MPEG decoder 8 and the on-screen display information (OSD) specific to the recorder/player set if necessary. The digital video data is converted to the analog video data by the video encoder 11, and sent to the TV monitor. The TV monitor displays the reproduced main video or synthesized video of the main video and OSD.

Moreover, when the broadcasting system is converted by the broadcasting system conversion section 9, and the converted video data is recorded in the DVD as described above, the output of the MPEG decoder 8 is different from that of the broadcasting system specific to the TV monitor. In this case, when the converted video data is supplied to the TV monitor via the graphic LSI 10, synchronization is not established in the TV monitor, therefore the video rotates, and normal video is not displayed. Therefore, the OSD of the same broadcasting system as that of the TV monitor is output by the graphic LSI 10, and it is displayed by characters that the broadcasting system is converted to perform the copying. At this time, the main video that is not synchronized is masked, and states such as a copying state and progress state are displayed on the monitor by the OSD.

Furthermore, during the broadcasting system converting/copying, the video data whose broadcasting system has been converted is reduced, and the reduced video may also be synthesized with the OSD. In this case, in the video of the OSD that can be synchronized, the reduced video of another broadcasting system is embedded. The video that is not synchronized is displayed in a reduced screen.

As described above, each block is constituted as LSI, but these blocks may also be constituted of one or a plurality of LSIs.

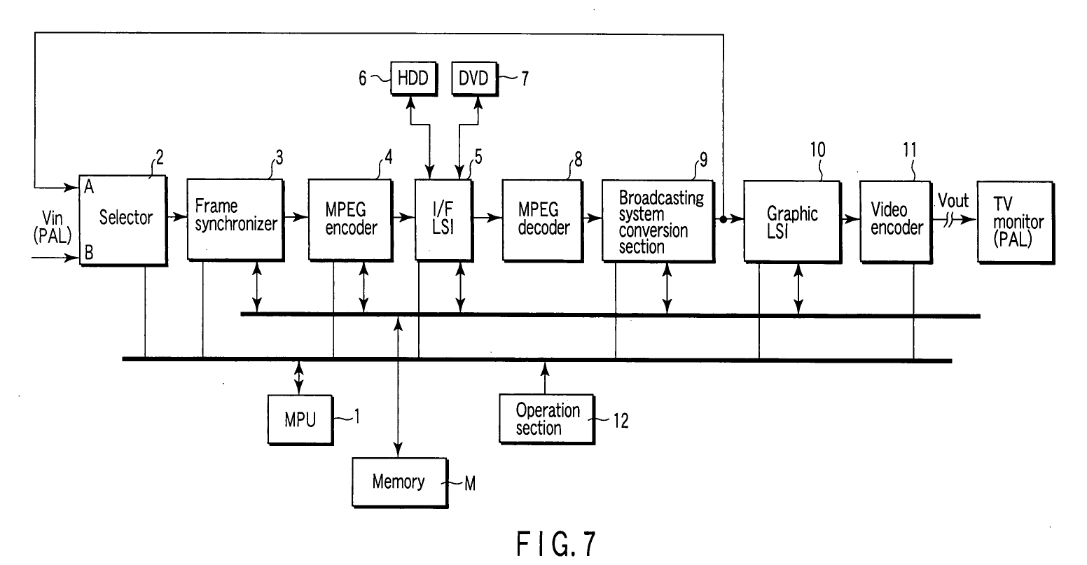

Moreover, in a constitution in which the respective blocks share one or a plurality of memories M as shown in FIG. 7, a necessary monitor capacity can be reduced.

Next, a second embodiment of the recording/reproducing apparatus according to the present invention will be described.

When the video data of PAL recorded in a DVD or HDD 6 is converted to the video data of NTSC and recorded in the HDD 6 or DVD in the second embodiment, a video being recorded is normally displayed on a TV monitor.

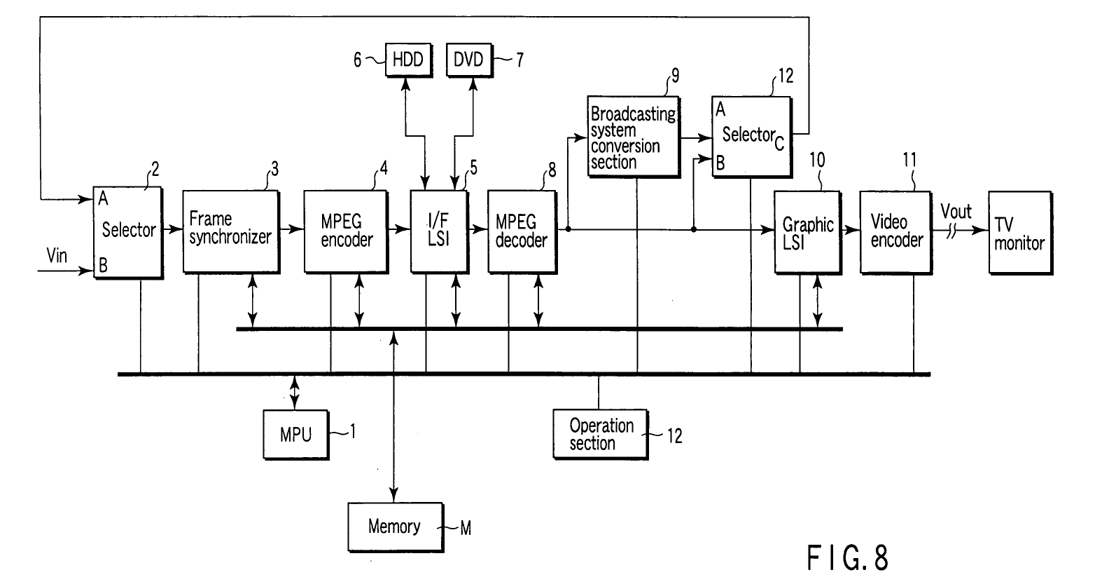

FIG. 8 is a block diagram showing the constitution of the recording/reproducing apparatus according to the second embodiment. An output signal of an MPEG decoder 8 is supplied to the broadcasting system conversion section 9, a selector 12, and a graphic LSI 10. The output signal of the broadcasting system conversion section 9 is supplied to the selector 12, and the output signal of the selector 12 is supplied to a selector 2.

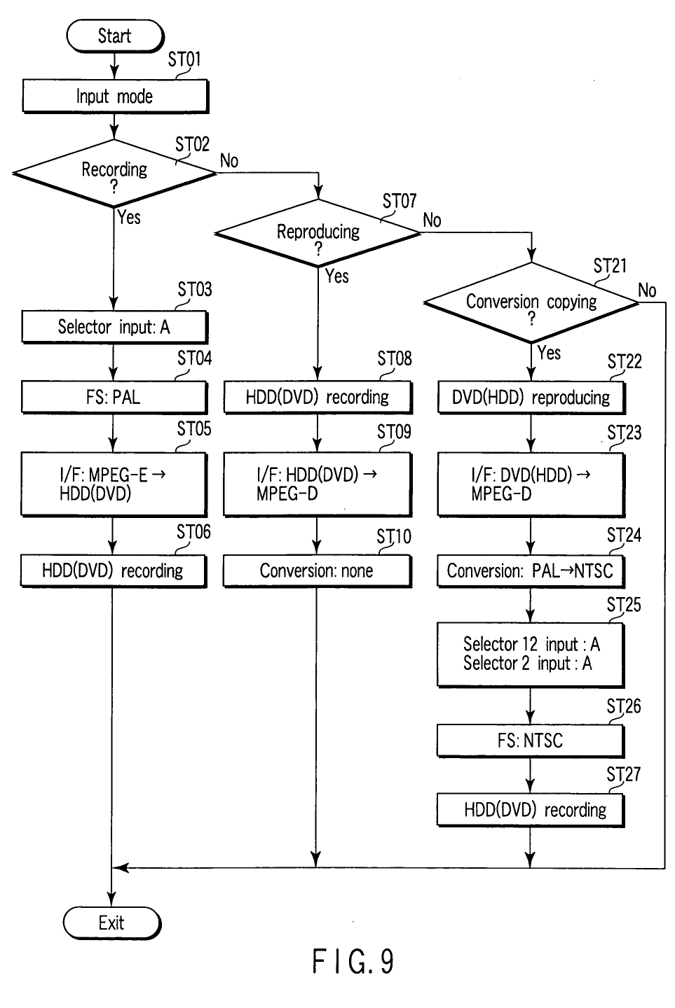

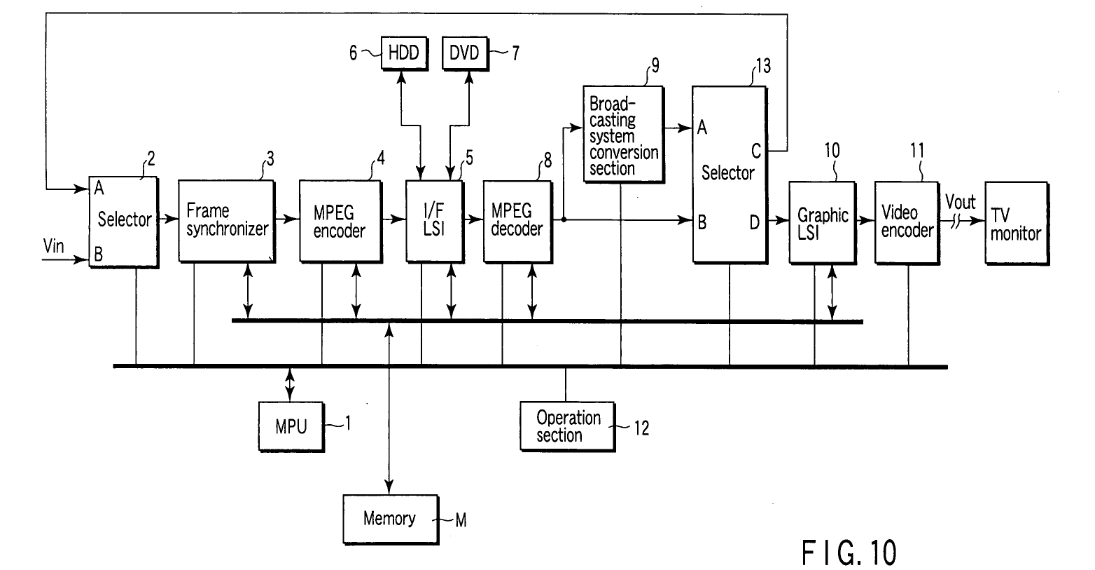

FIG. 9 is a flowchart showing an operation of the second embodiment. When the recording or reproducing is performed without converting the broadcasting system, an operation of the second embodiment is similar to that of the first embodiment.

The converting/copying operation in the second embodiment will hereinafter be described. Here, a case where the video data of PAL recorded in the DVD is converted to that of NTSC and recorded in the HDD 6 will be described.

When an instruction for converting the broadcasting system of the video data of the PAL recorded in the DVD into NTSC and copying the data into the HDD 6 is inputted via the operation section 12 from the user (YES in ST21), the MPU 1 sets the DVD drive 7 to the “reproducing mode”, sets the data path of the I/F LSI 5 to “the MPEG decoder 8 from DVD drive 7″, sets the broadcasting system conversion section to “the NTSC from PAL”, sets the input of the selector 12 to “A”, sets the input of the selector 2 to “A”, sets the data supplement of the frame synchronizer (FS) 8 to “the NTSC system”, and sets the HDD 6 to the “recording mode” (ST22 to ST27).

By this setting, the vide data of PAL recorded in the DVD is supplied to the MPEG decoder 8 via the I/F LSI 5, and decoded, and the data of the PAL system is converted to that of the NTSC system by the broadcasting system conversion section 9. The converted video data is returned to the selector 2 via the selector 12.

Here, the selector 2 selects the video signal (input A) from the broadcasting system conversion section 9, and sends the signal to the frame synchronizer 3. The frame synchronizer 3 carries out a frame synchronize process of the NTSC broadcasting system with respect to the inputted video data. The video signal subjected to the frame synchronize process is compressed by the MPEG encoder 4, and recorded by the HDD 6 via the I/F LSI 5.

During the converting/copying, the video data of the PAL decoded by the MPEG decoder 8 is supplied to the TV monitor via the graphic LSI 10 and video encoder 11, and normally displayed. In the present embodiment, the video being converted/copied can be monitored as a normal video in this manner.

Next, a third embodiment of the recording/reproducing apparatus according to the present invention will be described.

In the third embodiment, when the video data of NTSC or PAL recorded in the DVD or HDD 6 is converted to the video data of PAL or NTSC and recorded in the HDD 6 or DVD, the video being recorded is normally displayed on the TV monitor.

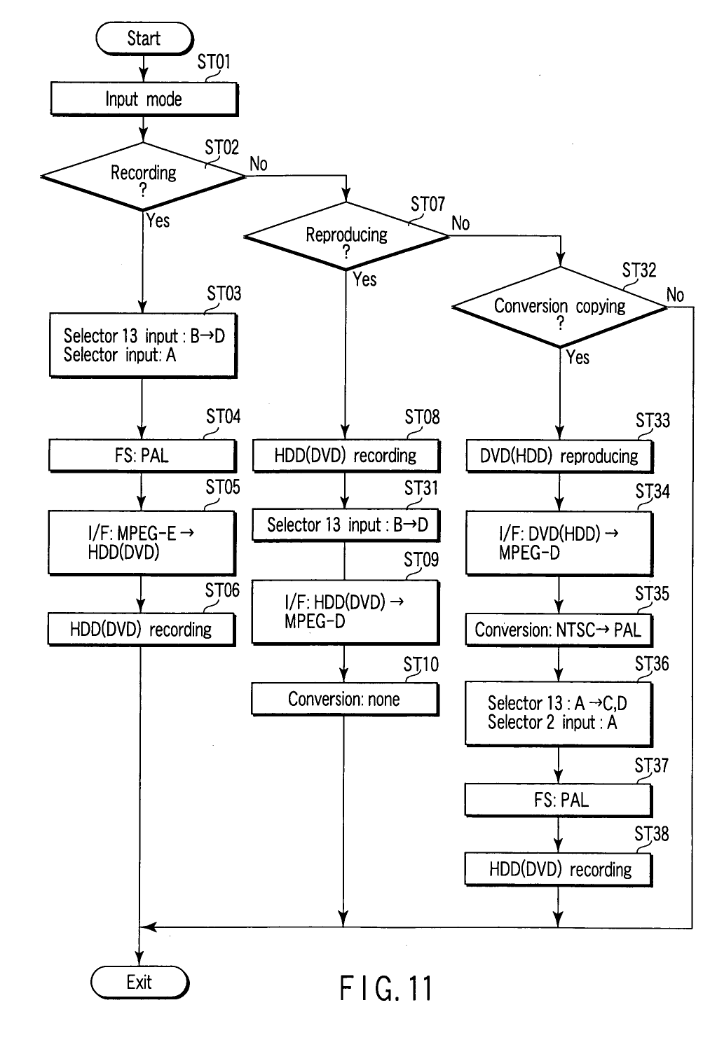

FIG. 10 is a block diagram showing the constitution of the recording/reproducing apparatus according to the third embodiment. The output signal of the MPEG decoder 8 is supplied to the broadcasting system conversion section 9 and a selector 13. The output signal of the broadcasting system conversion section 9 is supplied to the selector 13, the output signal from an output C of the selector 13 is supplied to the selector 2, and the output signal from an output D is supplied to the graphic LSI 10. The selector 13 has two modes: a first mode in which the signal inputted in “A” is outputted via “C” and “D”; and a second mode in which the signal inputted into “A” is outputted from “C” and the signal inputted in “B” is outputted from “D”.

FIG. 11 is a flowchart showing the operation of the third embodiment. When the recording is performed without converting the broadcasting system, the selector 13 is set in such a manner that the signal inputted in “B” is outputted from “D” as in step ST30. The other setting is similar to that of the first embodiment. Also when the reproducing is performed without converting the broadcasting system, the selector 13 is set in such a manner that the signal inputted in “B” is outputted from D” as in step ST31. The other setting is similar to that of the first embodiment.

The converting/copying operation in the third embodiment will hereinafter be described. Here, a case where the video data of NTSC recorded in the DVD is converted to that of PAL and recorded in the HDD 6 will be described.

When the instruction for converting the broadcasting system of the video data of the NTSC recorded in the DVD into PAL and copying the data into the HDD 6 is inputted via the operation section 12 from the user (YES in ST32), the MPU 1 sets the DVD drive 7 to the “reproducing mode”, sets the data path of the I/F LSI 5 to “the MPEG decoder 8 from DVD drive 7”, and sets the broadcasting system conversion section to “the PAL from NTSC” (ST33 to ST35). The MPU 1 sets the selector 2 so as to select the input “A”, and sets the selector 13 to the first mode, that is, so as to output the signal supplied to “A” from “C” and “D”. The MPU 1 further sets the data supplement of the frame synchronizer (FS) 8 to “PAL”, and sets the HDD 6 to the “recording mode” (ST37, ST38).

By this setting, the vide data of NTSC recorded in the DVD is supplied to the MPEG decoder 8 via the I/F LSI 5, and decoded, and the data of the NTSC system is converted to that of the PAL system by the broadcasting system conversion section 9. The converted video data is supplied to the selector 2 and graphic LSI 10 via the selector 13.

The selector 2 selects the video signal from the selector 13, and sends the signal to the frame synchronizer 3. The frame synchronizer 3 carries out the frame synchronize process of the PAL broadcasting system with respect to the inputted video data. The video signal subjected to the frame synchronize process is compressed by the MPEG encoder 4, and recorded by the HDD 6 via the I/F LSI 5.

During the converting/copying, the video data of the PAL decoded by the MPEG decoder 8 is supplied to the TV monitor via the selector 13, graphic LSI 10, and video encoder 11, and normally displayed. It is to be noted that when the video is converted and copied to the NTSC from PAL, the MPU 1 sets the selector 13 in the second mode, that is, the mode in which the signal inputted into “A” is outputted from “C” and the signal inputted into “B” is outputted from “D”. The data supplement of the frame synchronizer (FS) 3 is set to “NTSC”. In the embodiments, the video being copied can be monitored as the normal video not only during the converting/copying to the NTSC from PAL but also during the converting/copying to PAL from NTSC.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A video data recording apparatus comprising:
a first encode control section which uses an encoder to encode broadcasted video data;
a first recording section which records the encoded video data;
a decoder which decodes the video data recorded in the first recording section;
a broadcasting system conversion section which converts the decoded video data to video data of a broadcasting system other than that of the video data;
a second encode control section which uses the encoder to encode the video data of the other broadcasting system converted by the broadcasting system conversion section; and
a second recording section which records the encoded video data of the other broadcasting system.

2. The video data recording apparatus according to claim 1, further comprising:
a selection section which selects one of the broadcast video data and the video data of the other broadcasting system converted by the broadcasting system conversion section,
wherein the first encode control section selects the broadcast video data by the selection section, and the second encode control section selects the video data of the other broadcasting system by the selection section.

3. The video data recording apparatus according to claim 2, further comprising:
a data supplement section which supplements the video data selected by the selection section to supply standard video data of the same broadcasting system as that of the selected video data.

4. The video data recording apparatus according to claim 3, wherein the data supplement section includes a PAL system data supplement section which supplements PAL system video data, and an NTSC system data supplement section which supplements NTSC system video data.

5. The video data recording apparatus according to claim 3, wherein the data supplement section detects the broadcasting system of input video data to supplement the data in accordance with the detected broadcasting system.

6. The video data recording apparatus according to claim 5, wherein the data supplement section detects a synchronous data interval of the input video data to detect the broadcasting system of the input video data.

7. The video data recording apparatus according to claim 1, wherein the broadcasting system conversion section includes a PAL/NTSC conversion section and an NTSC/PAL conversion section.

8. The video data recording apparatus according to claim 1, wherein the first recording section includes a hard disc drive, and the second recording section includes a DVD recorder.

9. The video data recording apparatus according to claim 1, further comprising:
an image generation section which generates an OSD image indicating a conversion operation state in a first broadcasting system, when the broadcasting system conversion section converts the first broadcasting system video data into second broadcasting system video data.

10. The video data recording apparatus according to claim 9, wherein the image generation section synthesizes the second broadcasting system video data supplied by the broadcasting system conversion section with the OSD image.

11. The video data recording apparatus according to claim 2, further comprising: a second selection section which selects one of the video data outputted from the broadcasting system conversion section and the MPEG decoder to supply the video data to the selection section.

12. The video data recording apparatus according to claim 2, further comprising:
a video encoder which converts digital video data into an analog video signal; and
a second selection section including a first mode to supply the video data outputted from the broadcasting system conversion section to the selection section and the video encoder and a second mode to provide the video data outputted from the broadcasting system conversion section to the selection section and to supply the video data outputted from the decoder to the video encoder.

13. A video data recording method comprising:
using an encoder to encode broadcast video data;
recording the encoded video data in a first recording medium;
decoding the video data recorded in the first recording medium;
converting the decoded video data to video data of a broadcasting system other than that of the video data;
using the encoder to encode the video data of the other broadcasting system; and
recording the encoded video data of the other broadcasting system in a second recording medium.
